(19) United States
(12) Patent Application Publication
(10) Pub. No.: US 2019/0053255 A1
(43) Pub. Date: Feb. 14, 2019

(54) SR CONFIGURATION FOR ENABLING SERVICES OF DIFFERENT PRIORITIES

(71) Applicant: QUALCOMM Incorporated, San Diego, CA (US)

(72) Inventors: Chih-Ping Li, San Diego, CA (US); Wanshi Chen, San Diego, CA (US); Gavin Bernard Horn, La Jolla, CA (US); Jing Jiang, San Diego, CA (US); Linhai He, San Diego, CA (US); Seyedkianoush Hosseini, San Diego, CA (US)

(21) Appl. No.: 16/058,731

(22) Filed: Aug. 8, 2018

Related U.S. Application Data
(60) Provisional application No. 62/544,701, filed on Aug. 11, 2017.

(51) Int. Cl. H04W 72/12; H04L 12/24

(52) U.S. Cl. CPC H04W 72/12; H04W 88/02; H04L 41/08

(57) ABSTRACT

In a network configured to communicate over multiple services, each service may have one or more SR configurations. In embodiments, a processor may detects SR collision in which SR occasions for different services as defined by their corresponding configurations at least partially overlap. Based at least on the detected potential collisions, the processor may take action to resolve the collision

### CROSS-REFERENCE TO RELATED APPLICATIONS

This application claims the benefit of U.S. Provisional Patent Application No. 62/544,701, entitled, “SR CONFIGURATION FOR ENABLING SERVICES OF DIFFERENT PRIORITIES,” filed on Aug. 11, 2017, which is expressly incorporated by reference herein in its entirety.

### BACKGROUND

### Field

Aspects of the present disclosure relate generally to wireless communication systems, and more particularly, to managing SRs in a network that supports multiple communication services.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a method of wireless communication is disclosed. The method may include communicating over a plurality of different services, each having a corresponding scheduling request (SR) configuration; detecting a potential occurrence of an SR collision based on the plurality of SR configurations, wherein an SR collision occurs when an SR occasion of a first service in the plurality of services and an SR occasion of a second service in the plurality of services at least partially overlap; and resolving the potential occurrence of the SR collision.

In an additional aspect of the disclosure, a system of wireless communication is disclosed. The system may include means for communicating over a plurality of different services, each having a corresponding scheduling request (SR) configuration; means for detecting a potential occurrence of an SR collision based on the plurality of SR configurations, wherein an SR collision occurs when an SR occasion of a first service in the plurality of services and an SR occasion of a second service in the plurality of services at least partially overlap; and means for resolving the potential occurrence of the SR collision.

In an additional aspect of the disclosure, a non-transitory computer-readable medium having program code recorded thereon. The program code further includes code for communicating over a plurality of different services, each having a corresponding scheduling request (SR) configuration; code for detecting a potential occurrence of an SR collision based on the plurality of SR configurations, wherein an SR collision occurs when an SR occasion of a first service in the plurality of services and an SR occasion of a second service in the plurality of services at least partially overlap; and code for resolving the potential occurrence of the SR collision.

In an additional aspect of the disclosure, an apparatus configured for wireless communication is disclosed. The apparatus includes at least one processor, and a memory coupled to the processor. The processor is configured to detect a potential occurrence of an SR collision based on the plurality of SR configurations, wherein an SR collision occurs when an SR occasion of a first service in the plurality of services and an SR occasion of a second service in the plurality of services at least partially overlap, and further configure to resolve the potential occurrence of the SR collision. Further, a transceiver may be configured to communicate over a plurality of different services, each having a corresponding scheduling request (SR) configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3 is a timing diagram illustrating communication details according to one aspect of the present disclosure.

FIG. 4A is a timing diagram illustrating communication details according to one aspect of the present disclosure.

FIG. 4B is a timing diagram illustrating communication details according to one aspect of the present disclosure.

FIG. 5A is a flow chart illustrating communication details according to one aspect of the present disclosure.

FIG. 5B is a flow chart illustrating communication details according to one aspect of the present disclosure.

FIG. 5C is a flow chart illustrating communication details according to one aspect of the present disclosure.

### DETAILED DESCRIPTION

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 1.00+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

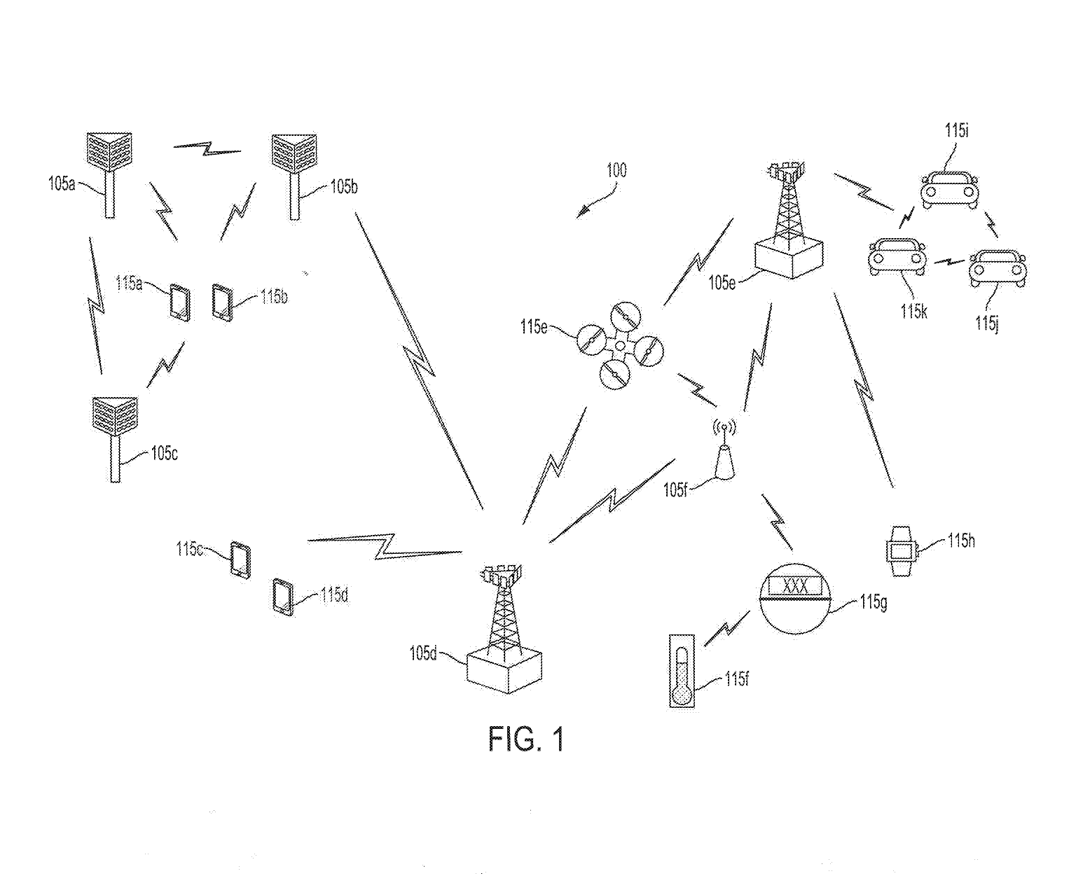

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PD), a wireless modem, a wireless communication device, a handheld device, a tablet computer, a laptop computer, a cordless phone, a wireless local loop (WLL) station, or the like. In one aspect, a UE may be a device that includes a Universal Integrated Circuit Card (UICC). In another aspect, a UE may be a device that does not include a UICC. In some aspects, UEs that do not include UICCs may also be referred to as internet of everything (IoE) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations,

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts,

5G network 100 also support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

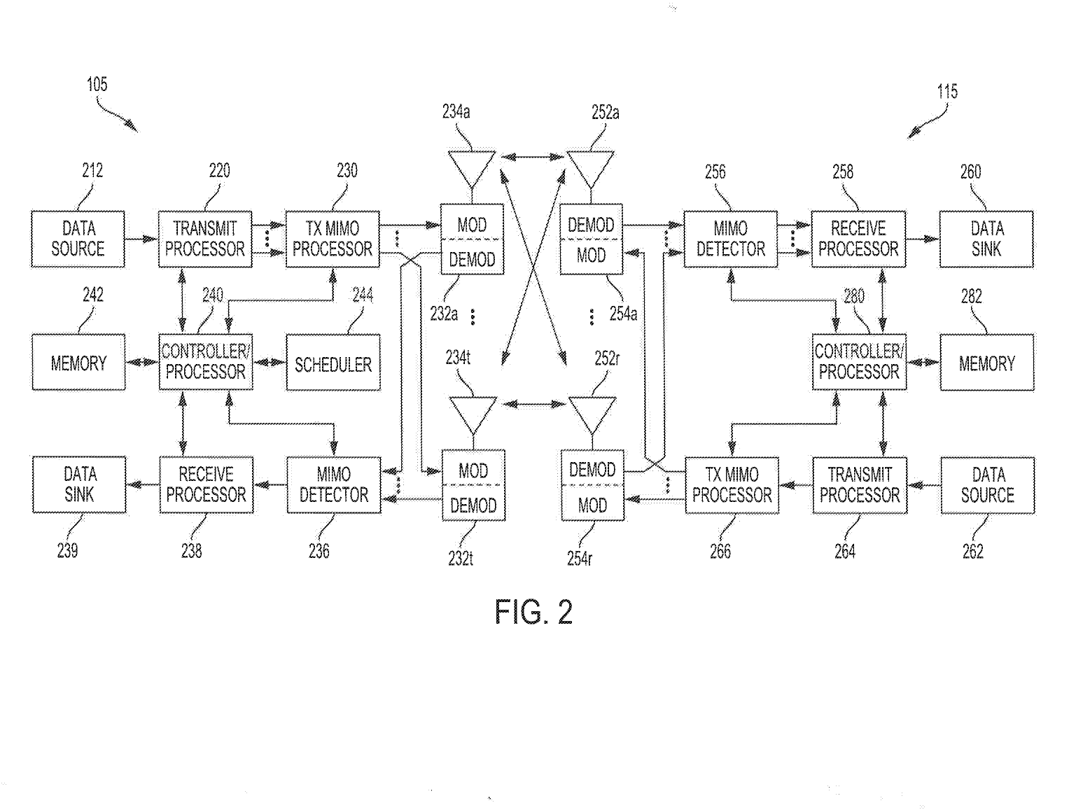

FIG. 2 shows a block diagram of a design of a base station 105 and a UE 115, which may be one of the base station and one of the UEs in FIG, 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e,g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MEMO detector 236 if applicable, and further processed by a receive processor 238 to obtain decoded data and control information sent by the UE 115. The processor 238 may provide the decoded data to a data sink 239 and the decoded control information to the controller/processor 240.

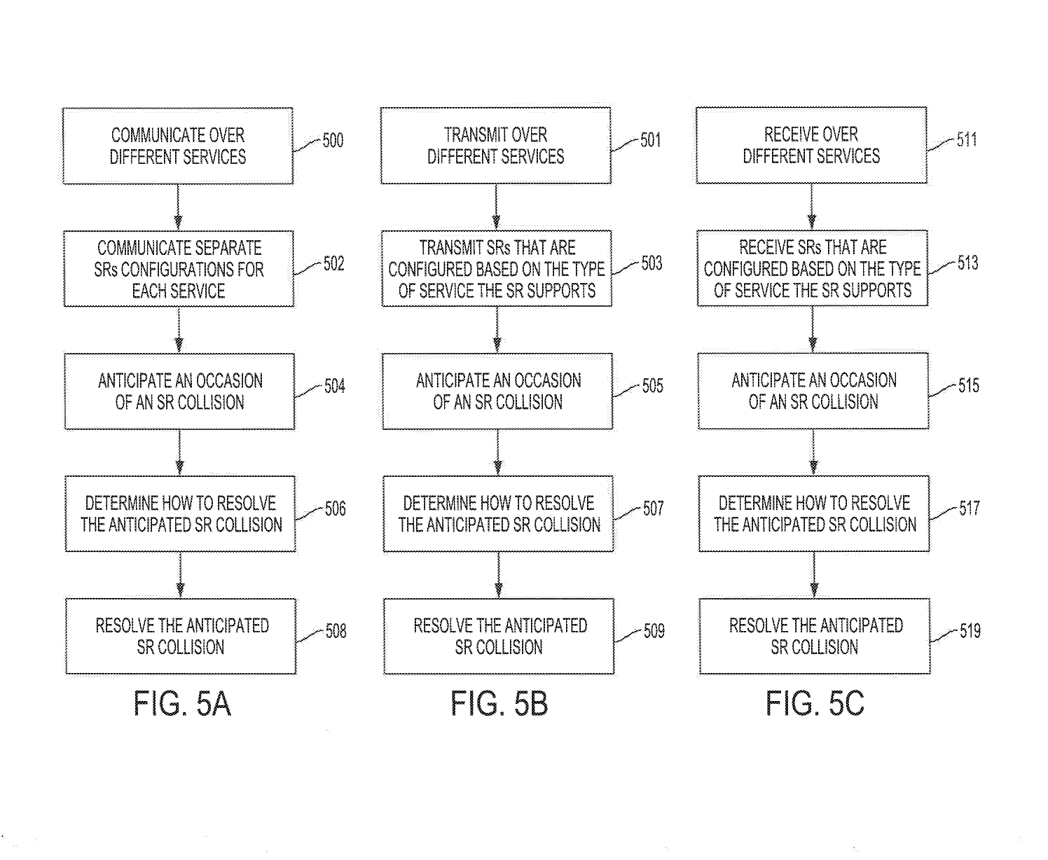

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIGS. 5A-5B, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

Use of a medium-sensing procedure to contend for access to an unlicensed shared spectrum may result in communication inefficiencies. This may be particularly evident when multiple network operating entities (e.g., network operators) are attempting to access a shared resource. In 5G network 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In communications network 100, one or more UE 115 may want to transmit information on the UL. When data becomes available for transmission in the UL, the UE may not have access to the UL resources for at least sending the BSR. In such a case, the UE's MAC may trigger an Scheduling Request (SR). An SR may be used to request uplink resources for a transmission. For example, UE 15 may transmit an SR to request UL-SCH resources for a new uplink transmission.

An SR may be sent on the uplink control channel (PUCCH). The configuration of an SR may be pre-configured for the UE. For example, a base station may configure a UE with the SR configuration via RRC signaling. The SR configuration may indicate the sr-PUCCH-Resourceindex, the sr-Congifindex, etc. In embodiments, the sr-PUCCH-Resourceindex indicates the SR resources in the frequency domain. In embodiments, the sr-CongifIndex indicates the RS resources in the time domain. Based on the configuration parameters, the UE may compute an SR's periodicity and offset and send SRs when desired in the indicated time and frequency resources.

In an LTE example, based on the configuration parameters defined by the base station, the UE may compute an SR's periodicity and send an SR during the next scheduled SR opportunity. That being said, as users demand faster and faster data speeds, additional services are being offered, as explained above) and the additional services have lower latency requirements. As such, to meet the lower latency requirements, a UE may need to send an SR for a grant-based UL transmission as fast as possible. Hence, reducing the periodicity between SR opportunities is desired. Nonetheless, in addition to supporting services having low latency requirements to appease users demanding increase data communications, UE may simultaneously support other services (e.g., legacy services) that have higher latency requirements.

As such, it is desired that a network support multiple communications on services having lower latency requirements as well as services having higher latency requirements. Accordingly, networks would benefit from having the capability to communicate on difference services (e.g., services of different priorities). Some examples of services include, but are not limited to, 5G NR eMBB, 5G NR URLLC, IoT, LTE ULL, LTE HRLLC, etc. The services may be ranked according to a priority level. For example, URLLC may be ranked as having a higher priority level than eMBB; of course, the ranking levels may be defined differently if desired. In embodiments, the ranking levels may be based on latency requirements, quality of Service requirements, and/or more. Of course, the ranking levels may be based on other information, rules, and/or requirements as is desired. Further, user side devices (e.g., UE) and/or network side devices (e.g., base stations) may be configured to know ranking levels of the various services.

In networks designed to support multiple services of differing priorities, a UE may be configured to request UL resources according to the needs of a particular service. For example, a UE may be configured such that SR opportunities for higher priority services are available at a higher rate as compared to SR opportunities for lower priority services in order to allocate transmission opportunities accordingly. Further, in networks designed to support multiple services of differing priorities, a base station may be configured to distinguish between SRs received for different priority services in order to allocate UL resources accordingly.

In embodiments, SRs of different services may be configured differently. For example, an SR for eMBB may be configured differently than an SR for URLLC. By configuring the SRs differently, a base station is able to distinguish the SRs.

In embodiments, each service (of the multiple services) may have a set of SR resources. The SR resources may be subject to different parameters. Example parameters may include by are not limited to periodicity, offset, prohibit timers, maximum number of attempts, etc.

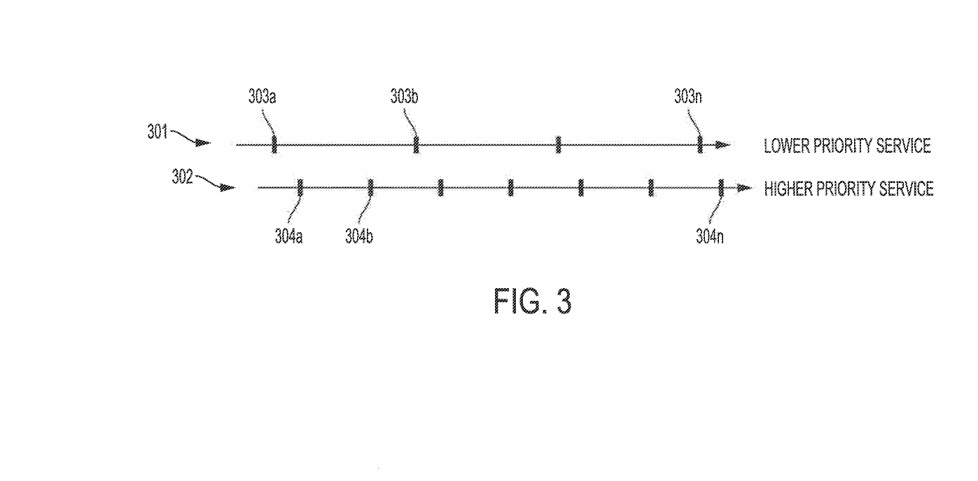

FIG. 3 shows an example in the time domain of a lower priority service 301 having a different period as compared to a higher priority service 302. In this example, SR opportunities are shown at 303a-303n and 304a-304n. As such, the lower priority service 301 has a longer period as compared to the higher priority service 302 in this example. In embodiments, lower priority service 301 may be eMBB and higher priority service 302 may be URLLC. The example shown in FIG. 3 only shows two different services for explanation reasons, but of course, the network may be configured to support any number of different services each ranked according to their priority level. The network may be configured such that each of the different services have their own separate SR opportunities which are computable by the UE and base station. For the sake of clarity, the example will proceed with two different services.

In embodiments, UE 115 may be configured to only send SR transmissions for a higher priority service during an SR opportunity configured for that higher priority service. Further, UE 115 may be configured to only send SR transmissions for a lower priority service during an SR opportunity configured for that lower priority service. In such an embodiments, a base station may distinguish the higher priority SR from the lower priority SR based at least on the timing of the SR transmission.

In embodiment, UE 115 may be configure to only send SR transmissions for a lower priority service during an SR opportunity configured for that lower priority service, but also be configured to send SR transmissions for a higher priority service during any SR opportunity (e.g., higher priority SR opportunity 304 or lower priority SR opportunity 303). In such an embodiment, a base station may distinguish the higher priority SR from the lower priority SR using information in addition to the timing of the SR transmission. In an example, a base station may distinguish an SR based at least on the SR's PUCCH format. In embodiments, a lower priority SR may use a long PUCCH (e.g., eMBB) and a higher priority SR may use a short PUCCH format (e.g., URLLC).

From time to time, circumstances may arise wherein a UE has more than one SR (or more than one priority level of SRs) available to transmit at the same time, e.g., when new data from high priority and low priority arrive at the same time to be transmitted on the uplink. Transmitting more than one SR (or more than one priority level of SRs) at the same time may result in an SR collision. An SR collision of two or more SRs may cause the loss of information of one or more of the colliding SRs. As such, avoiding SR collisions is desirable. In embodiments, a UE and/or base station may determine that an SR collision is likely to occur at an SR opportunity. Based on this anticipation of a potential SR collision, the UE and/or base station may take steps to prevent the collision as is described below.

In embodiments, SR collisions may be avoided via parallel transmissions. For example, in embodiments, a UE is configured for parallel transmission of multiple SRs, wherein some of the plurality of SRs may be of differing priority levels. These UEs may be free of power limitations that could prevent parallel transmissions. In embodiments, the UE may be configured to send one or more available SRs regardless of the SRs' service priority level. In embodiments, the UE may be configured to send one or more available SRs of a subset service priority levels. In an example, a network may support first, second, and third services respectively defined as having a low, medium, and high priority levels, respectively. A UE of this network may be configured to transmit high priority SRs during a high priority SR opportunity, transmit high and medium priority SRs during a medium priority SR opportunity, and transmit high, medium, and low priority SRs during a low priority SR opportunity.

In embodiments, a UE may avoid SR collisions by sending a single SR (or SRs of a single priority type) during an SR opportunity. This SR collision avoidance configuration may be used if and/or when a UE is power limited. Further, this SR collision avoidance configuration may be used in networks that do not support simultaneous transmission of PUCCHs of different durations. For example, in a network wherein maintaining phase continuity over a longer PUCCH is difficult or not possible, the transmission of PUCCHs of different durations may be avoided.

In embodiments that send a single SR during an SR opportunity, a UE may determine which SR of a plurality of available SRs to send during an SR opportunity, A UE may select an SR based on the SR's priority level. For example, if SR 1 supports a first service of a high priority level and SR 2 supports a second service of a lower priority level, then a USE may select SR 1 for transmission on a particular SR opportunity because SR 1's priority is higher. For instance, a UE may select a URLLC SR over an eMBB SR for transmission in the next SR opportunity. In embodiments wherein a UE is selecting from three SRs of three different priority levels, the UE may select the SR of the highest priority level for transmission on the next SR opportunity. Of course, the UE may be configured to make the selection differently, for example, a lower priority SR may be selected over a higher priority SR, for one or more reasons (e.g., the type of SR opportunity). Upon selecting an SR for transmission, the UE may drop the non-selected SRs. Further, the UE may delay transmission of the non-selected SRs until another SR opportunity. Of course the above example may be extended to embodiments that send a single type of SRs during an SR opportunity, wherein a UE determines which type of SRs to send during an SR opportunity.

In embodiments, an SR may be configured as a one-bit SR or may configured as a multi-bit SR. In embodiments wherein an SR is configured as a multi-bit SR, the SR may indicate whether UL resources for one service or multiple services are requested. For example, one or more of the bits may indicate that one, two, or more different services are requesting UL resources. Further, one or more of the bits may indicate which of the different services are being requested in the SR. For example, one or more of the bits may indicate that UL services are being requested for a higher priority service (e.g., URLLC) and a lower priority service (e.g., eMBB). Utilizing a multi-bit SR to request resources for a plurality of services is another way of avoiding collisions. For example, instead of a UE being faced with selecting between two SRs that are available for transmission at the same time, multiple UL resource requests are packaged into a single SR that is a multi-bit SR, and the multi-bit SR is transmitted on the next SR opportunity without risk of colliding With another SR being simultaneously transmitted.

FIGS, 4A and 4B show embodiments wherein SR interruption is handled. For instance, a high priority SR may become available for transmission while a low priority SR is in the process of transmitting. Given this circumstance, a UE may be configured to interrupt the currently transmitting SR. Networks supporting any configuration of SRs described herein may experience this circumstance. For instance, in a multi-bit SR configuration, the multi-bit SR in the process of being transmitted may contain UL resource requests for low and medium services while the newly available multi-bit SR may comprise UL resource requests for a high priority service.

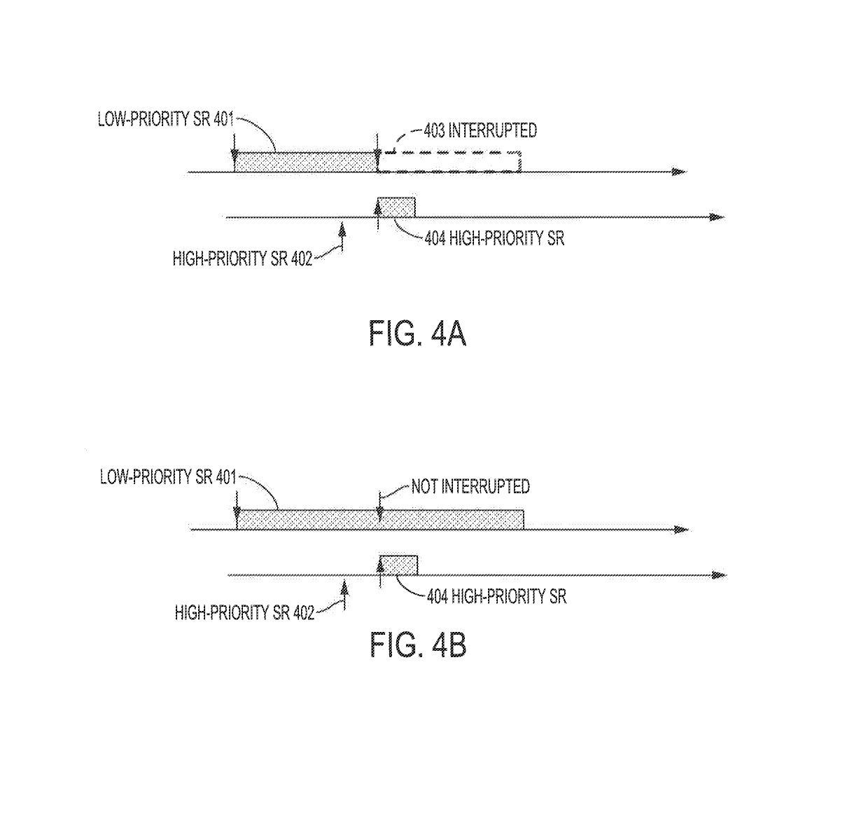

FIG. 4A shows an example of a UE interrupting the transmission of a low priority SR to begin transmission of a newly available high priority SR. In this example, at the time that an SR opportunity becomes available, UE 115 decides to transmit low-priority SR 401. After beginning transmission, a new SR 402 becomes available and that new SR 402 is of a higher service that the service of low-priority SR 401. In embodiments, the UE is configured to interrupt the low-priority SR 403 and begin transmitting the high-priority SR 404.

In embodiments, the UE is configured to determine whether to perform the interruption. For example, the determination may be based at least on the amount of priority level difference between the currently transmitting SR and the new higher-priority SR. For example, the UE may interrupt a low priority SR to transmit a high priority SR, but the UE may not interrupt a medium priority SR to transmit a high priority SR. The determination may be based at least on an amount of time left in the current SR opportunity. For example, the UE may refrain from interrupting the current SR transmission if the SR opportunity lacks enough remaining time to fully transmit the higher priority SR or due to the increased complexity of executing the interruption. The UE may be configured with any number and combination of rules to determine whether to interrupt the current low-priority transmission.

FIG. 4B shows an example of a UE that does not perform the above described interruption. The UE may be configured to such that interruption is not an option. The UE may be configured to perform parallel transmission if a new SR become available during the SR opportunity. Further, the UE may be configured to decide to perform parallel transmission as opposed to perform interruption (e.g., based on power capabilities).

In embodiments, a service may be configured with multiple sets of SR configurations, each with their own parameters (e.g., periodicity, offset, etc.), which are computable by the UE and the base station. As such, aperiodic SR opportunities are supported by the network. For example, in FIG. 3, lower priority service 301 may have SR opportunities in 1 ms periods that start at time t. The network may double the SR opportunities, if desired, by adding SR opportunities in 1 ms periods that start at time t+x (e.g., offset of x). Of course any of the priority services may be configured with increased SR opportunities as is desired. Further, the offsets and the periods of the various SR opportunities may vary as is desired.

FIG. 5A shows an example method that wherein a network supports multiple services. In step 500, one or more transmitters and/or receivers of the network communicates over multiple services (e.g., 5G NR eMBB, 5G NR URLLC, IoT, LTE ULL, LTE HRLLC, etc.). In step 502, one or more transmitters and/or receivers of the network communicates different SR configurations for the different services. In step 504, one or more processors of the network detects an occasion of an SR collision. In step 506, one or more processors of the network determines how to resolve the potential collision. In step 508, one or more processors of the network resolves the anticipated collision. In FIG. 5A, the one or more processors may be user side (e.g., UE) and/or server side (e.g., base station).

FIG. 5B shows an example method that wherein a UE supports multiple services. In step 501, one or more transmitters of the UE transmits over multiple services (e.g., 5G NR eMBB, 5G NR URLLC, IoT, LTE ULL, LTE HRLLC, etc.). In step 503, one or more transmitters of the UE transmits according to different SR configurations for the different services. In step 505, one or more processors of the UE detects an occasion of an SR collision. In step 507, one or more processors of the UE determines how to resolve the potential collision. The UE may make the determination according to any determination technique described above. In embodiments, UE may be configured to resolve the potential according to a resolution technique that is defined by the network. In such a circumstance, the UE may skip determination 507 and instead be configured to move from the detecting step 505 to the resolution step 509. In step 509, one or more processors of the UE resolves the anticipated collision. The UE may resolve the anticipated collision according to any resolution technique described above.

FIG. 5C shows an example method that wherein a base station supports multiple services. In step 511, one or more receivers of the base station receives UL resource requests over multiple services (e.g., 5G NR eMBB, 5G NR URLLC, IoT, LTE ULL, LTE HRLLC etc.). In step 513, one or more receivers of the base station receives UL resource requests according to different SR configurations for the different services. In step 515, one or more processors of the base station detects a potential occasion of an SR collision. A potential occasion of collision may occur when an SR opportunity of a first service overlaps with an SR opportunity of a second service. In step 517, one or more processors of the base determines how to resolve the potential collision. In an example, the base station may resolve overlapping SR opportunities by suspending one or more of the SR opportunities. In embodiments, a base station may suspend one or more lower SR opportunity and refrain from suspending the highest of the SR opportunities. In some networks, base station may be configured to simple suspend all overlapping SR opportunities. In such a circumstance, the base station may skip determination 517 and instead be configured to move from the detecting step 515 to the resolution step 519. In step 509, one or more processors of the base station resolves the anticipated collision.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 5A-5C may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (MID), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication by a user equipment (UE), comprising:
identifying a plurality of scheduling request (SR) configurations, each SR configuration associated with one or more services in a plurality of services over which the UE communicates with a base station;
detecting a potential occurrence of an SR collision based on the plurality of SR configurations, wherein an SR collision occurs when an SR opportunity of a first service in the plurality of services and an SR opportunity of a second service in the plurality of services at least partially overlap;
resolving the potential occurrence of the SR collision; and
communicating with the base station in accordance with resolving the potential occurrence of the SR collision.

2. The method of claim 1 wherein the resolving of the potential occurrence of the SR collision comprises:
determining a priority of the first service and a priority of the second service; and
wherein the communicating comprises:
transmitting, an SR associated with the first service when the first service has a higher priority than the second service; and
refraining from transmitting an SR associated with the second service when the second service has a lower priority than the first service.

3. The method of claim 2 wherein the refraining is performed based on a transmit power level of a UE performing the transmitting.

4. The method of claim 1 wherein resolving the potential occurrence of the SR collision comprises:
transmitting, during an SR opportunity a scheduling request for each of the plurality of services based on the corresponding SR configurations.

5. The method of claim 1 wherein resolving the potential occurrence of the SR collision comprises:
interrupting one or more SR that is currently transmitting; and
transmitting a different one or more SR during an SR opportunity.

6. The method of claim 5 wherein the interrupted one or more SR has a lower priority than the different one or more SR.

7. The method of claim 1 wherein resolving the potential occurrence of the SR collision comprises:
detecting the at least partially overlapping SR opportunities; and
suspending SR transmission in one or more of the at least partially overlapping SR opportunities.

8. The method of claim 1 wherein resolving the potential occurrence of the SR collision comprises:
suspending SR for one or more low priority services in the plurality of services.

9. The method of claim 1, further comprising:
receiving a control signal identifying one or more low priority services; and
suspending SR for the one or more low priority services based on the control signal.

10. The method of claim 2 wherein the one or more SRs are one bit SRs.

11. The method of claim 2 wherein the one or more SRs are multi-bit SRs.

12. The method of claim 11 wherein a multi-bit SR is a single SR transmission which signals SR for more than one service.

13. The method of claim 2 wherein the SR opportunity of the first service, the SR opportunity of the second service, or both, may be an aperiodic SR opportunity.

14. The method of claim 2 wherein at least one of the plurality of services is associated with a plurality of SR configurations.

15. An apparatus for wireless communication, comprising:
means for identifying a plurality of scheduling request (SR) configurations, each SR configuration associated with one or more services in a plurality of services over which a UE communicates with a base station;
means for detecting a potential occurrence of an SR collision based on the plurality of SR configurations, wherein an SR collision occurs when an SR occasion of a first service in the plurality of services and an SR occasion of a second service in the plurality of services at least partially overlap;
means for resolving the potential occurrence of the SR collision; and
means for communicating with the base station in accordance with resolving the potential occurrence of the SR collision.

16. The apparatus of claim 15 wherein the resolving of the potential occurrence of the SR collision comprises:
means for determining a priority of the first service and a priority of the second service; and
wherein the communicating comprises:
means for transmitting, an SR associated with the first service when the first service has a higher priority than the second service; and
means for refraining from transmitting an SR associated with the second service when the second service has a lower priority than the first service.

17. The apparatus of claim 16 wherein the refraining is performed based on a transmit power level of a UE performing the transmitting.

18. The apparatus of claim 15 wherein the means for resolving the potential occurrence of the SR collision comprises:
means for transmitting, during an SR opportunity, a scheduling request for each of the plurality of services based on the corresponding SR configurations.

19. The apparatus of claim 15 wherein the means for resolving the potential occurrence of the SR collision comprises:
means for interrupting one or more SR that is currently transmitting; and
means for transmitting a different one or more SR during an SR opportunity.

20. The apparatus of claim 19 wherein the interrupted one or more SR has a lower priority than the different one or more SR.

21. The apparatus of claim 15 wherein the means for resolving the potential occurrence of the SR collision comprises:
means for detecting the at least partially overlapping SR opportunities prior to the scheduled overlap; and
means for suspending SR transmission in one or more of the at least partially overlapping SR opportunities.

22. The apparatus of claim 15 wherein the means for resolving the potential occurrence of the SR collision comprises:
means for suspending SR for one or more low priority services in the plurality of services.

23. The apparatus of claim 15, further comprising:
means for receiving a control signal identifying one or more low priority services; and
means for suspending SR for the one or more low priority services based on the control signal.

24. The apparatus of claim 16 wherein the one or more SRs are one bit SRs.

25. The apparatus of claim 16 wherein the one or more SRs are multi-bit SRs.

26. The apparatus of claim 25 wherein a multi-bit SR is a single SR transmission which signals SR for more than one service.

27. The apparatus of claim 16 wherein the SR opportunity of the first service, the SR opportunity of the second service, or both, may be an aperiodic SR opportunity.

28. The apparatus of claim 16 wherein at least one of the plurality of services is associated with a plurality of SR configurations.

29. A non-transitory computer-readable medium having program code recorded thereon, the program code comprising:
code for identifying a plurality of scheduling request (SR) configurations, each SR configuration associated with one or more services in a plurality of services over which a UE communicates with a base station;
code for detecting a potential occurrence of an SR collision based on the plurality of SR configurations, wherein an SR collision occurs when an SR opportunity of a first service in the plurality of services and an SR opportunity of a second service in the plurality of services at least partially overlap;
code for resolving the potential occurrence of the SR collision; and
code for communicating with the base station in accordance with resolving the potential occurrence of the SR collision.

30. The non-transitory computer-readable medium of claim 29 wherein the resolving of the potential occurrence of the SR collision comprises:
code for determining a priority of the first service and a priority of the second service; and
wherein the code for communicating comprises:
code for transmitting, an SR associated with the first service when the first service has a higher priority than the second service; and
code for refraining from transmitting an SR associated with the second service when the second service has a lower priority than the first service.

31. The non-transitory computer-readable medium of claim 29 wherein the code for resolving the potential occurrence of an SR collision comprises:
code for interrupting one or more SR that is currently transmitting; and
code for transmitting a different one or more SR during an SR opportunity.

32. An apparatus configured for wireless communication, comprising:
a transceiver configured to communicate with a base station over a plurality of different services, each service in the plurality of services having a corresponding scheduling request (SR) configuration; and
at least one processor configured to:
detect a potential occurrence of an SR collision based on the plurality of SR configurations, wherein an SR collision occurs when an SR opportunity of a first service in the plurality of services and an SR opportunity of a second service in the plurality of services at least partially overlap,
resolve the potential occurrence of the SR collision, and
communicate with the base station in accordance with resolving the potential occurrence of the SR collision.

33. The apparatus of claim 32 further comprising:
a transmitter configured to transmit an SR associated with the first service when the first service has a higher priority than the second service, wherein the at least one processor is further configured to determine a priority of the first service and a priority of the second service, and to cause the transmitter to refrain from transmitting an SR associated with the second service when the second service has a lower priority than the first service.

34. The apparatus of claim 33 wherein the at least one processor causes the transmitter to refrain from transmitting based at least on a transmit power level of the apparatus.

35. The apparatus of claim 32 wherein the at least one processor is further configured to interrupt transmission of one or more SRs and to cause a transmitter to transmit a different one or more SR during an SR opportunity.

36. The apparatus of claim 35 wherein the interrupted one or more SR has a lower priority than the different one or more SR.

37. The apparatus of claim 32 wherein the at least one processor is further configured to resolve the potential occurrence of an SR collision at least in part by detecting the at least partially overlapping SR opportunities and suspending SR transmission in one or more of the at least partially overlapping SR opportunities.

38. The apparatus of claim 32 wherein the at least one processor is further configured to resolve the potential occurrence of an SR collision at least in part by suspending SR for one or more low priority services in the plurality of services.

39. The apparatus of claim 32, further comprising:
a receiver configured to receive a control signal identifying one or more low priority services, wherein the at least one processor is configured to suspend SR for the one or more low priority services based on the control signal.

40. The apparatus of claim 33 wherein the one or more SRs are one bit.

41. The apparatus of claim 33 wherein the one or more SRs are multi-bit SRs.

42. The apparatus of claim 41 wherein a multi-bit SR is a single SR transmission which signals SR for more than one service.

43. The apparatus of claim 33 wherein the SR opportunity of the first service, the SR opportunity of the second service, or both, may be an aperiodic SR opportunity.

44. The apparatus of claim 33 wherein at least one of the plurality of services is associated with a plurality of SR configurations.
